(19) United States
(12) Patent Application Publication
(10) Pub. No.: US 2011/0022408 A1
(43) Pub. Date: Jan. 27, 2011

(54) HEALTH PLAN SUBROGATION SYSTEM

(76) Inventors: John Pramik, Westminster, MD (US); Janice K. Albert, Columbia, MD (US)

Correspondence Address: OBER / KALER;C/O ROYAL W. CRAIG, 120 EAST BALTIMORE STREET, SUITE 800, BALTIMORE, MD, 21202, US

(21) Appl. No.: 12/842,427

(22) Filed: Jul. 23, 2010

Related U.S. Application Data
(60) Provisional application No. 61/271,596, filed on Jul. 23, 2009.

(51) Int. Cl. G06Q 50/00

(52) U.S. Cl. 705/2

(57) ABSTRACT

A software system for providing assistance to third party healthcare payors and others in recouping funds to which they have a subrogation right. The system generally comprises a web enabled computer server and a dynamic information gathering module for instructing a processor to search a health insurance claims database for all claims of record meeting a specified criteria and display, and a search window for allowing a user to enter a selected black box drug and date range for searching said health insurance claims database. The software application can identify individuals who took a particular drug and had an adverse outcome, and can identify specific diagnoses which can be imputed back to drugs or chemical exposure (such as mesothelioma caused by exposure to asbestos, and liver toxicity caused by acetominophen (including combination drugs containing acetaminophen). The software system assists health insurers in collecting funds subject to a subrogation claim.

CROSS-REFERENCE TO RELATED APPLICATION(S)

The present application derives priority from U.S. provisional application Ser. No. 61/271,596 filed 23 Jul. 2009.

### BACKGROUND OF THE INVENTION

1. Field of the Invention

The present invention relates to software for the healthcare industry and, more particularly, to a software system for providing assistance to third party healthcare payors and others to assist them in identifying funds reimbursed for prescription drug (Rx) claims and medical claims, to which they may have a subrogation right (including plan members that collected settlement proceeds or legal recoveries for injuries or illness).

2. Discussion of the Related Art

A very large issue for healthcare insurers (“payors”) is their ability to identify opportunities that could lead to the recoupment of funds in cases where a plan member has collected payment for an injury even though the Health Plan has paid for the care of those individuals throughout their treatment/recovery/death from those exposures. This is often the case with motor vehicle accidents, pharmaceutical drug injury or illness, chemical or toxin exposure outside of the health plan. The term used in healthcare for these collections is subrogation. In many cases the plan member may have been a victim of exposure to chemical or drugs, and yet they remain unaware of the cause of their injuries. Thus, law firms who frequently represent these individuals can only find them through public awareness, hence the legal advertising that we see on television and other media. After the representation, it is unlikely that plan members would be desirous of sharing their compensation with the health plan that paid for their care.

Healthcare third party payors (insurers and the U.S. government) bear the burden of determining whether they've paid for a claim for which they weren't really liable. When this occurs, the payors often have a legal right to a subrogation claim. This is often the case with drugs that have been demonstrated to cause harm. The third party payor often reimburses the healthcare provider or patient for their medical expenses, and then the drug maker might pay the victims as part of a legal action. The third party payor is likely entitled to recoup a portion of the recovery proceeds, but it is exceedingly difficult to identify the individuals who took that particular drug and had the adverse outcome. It is clear that if these subrogation cases are investigated and managed the efforts usually leads to significantly higher recovery rates for the health plan, and in the long run this benefits the plan members by mitigating plan costs.

There are several types of commercially-available software systems that relate to subrogation, some addressing subrogation potential of a single claim (based primarily on previously successful subrogation instances) and some that examine larger amounts of data or claims to determine specific claims that may be favorably subrogated.

For example, U.S. Pat. No. 7,343,308 issued Mar. 11, 2008 discloses a method for weighing the subrogation potential of insurance claims. The method assigns a base score to a plurality of claims, factors the base score by risk factors for each of the select claims, and scores each of the selected claims depending on the base scores and identified risk factors to provide the expected subrogation recovery.

U.S. Patent Application No. 20080077451 by Anthony et al. is a more generalized system that evaluates (among other things) a likelihood of subrogation using a predictive model

U.S. Patent Application No. 20070016542 by Rosauer et al. shows a predictive analytics engine that is able to find patterns in data including insurance subrogation.

U.S. Patent Application No. 20070174094 by Mark S. Ramsey shows a system for evaluating subrogation potential of a specified insurance claim based on a comparison to a peer group of previous claims and their outcomes that are expected to include similar behaviors as the target claim that were successfully subrogated is established to determine a normal behavior that the target claim is supposed to include. A behavior of the target claim is compared to the normal behavior to evaluate a subrogation potential of the target claim. Proper subrogation solutions are prospectively chosen based on the determined normal behavior to increase efficiency.

Similarly, Subrosource™ software by Trumbull Services (http://www.trumbull-services.com/recovery_services_overview.html) scores subrogation claims to identify like-to-like situations based on previous data.

Clear Technology, Inc. produces subrogation software (http://www.clear-technology.com/powerful-solutions/subrogation-IDandScoring.shtml) that evaluates open and/or closed claims to identify missed subrogation opportunities and assigns a score to each claim based on the probability of recovery. The scores are then utilized to prioritize resources and take the most effective steps to subrogate a claim.

Lexis Nexis™ also distributes Choicepoint Subrofocus™ software (http://www.choicepoint.com/products/subrofocus.html) that uses predictive analytic and data mining techniques to identify patterns in internal data and prioritize claims based on the likelihood of subrogation recovery.

Socrates, Inc. produces MySocrates™ health claim subrogation identification software (http://www.socratesinc.com/WPSMS004.pdf) that purports to assist in recovery for both medical (DX) claims as well as pharmacy (RX) claims.

Despite their general goal of subrogation recovery, all of the above software programs focus on more typical subrogation cases such as property and casualty claims or accidents (falling down the stairs at WalMart™), Motor Vehical Accidents (MVAs), and recovery for things that are not disease or drug related. To the extent that they mention the use of Predictive Modeling, it is to determine the likelihood of recovery in a particular case, not the incidence of injury from prescription drugs or toxic exposure.

What is needed is a tool to evaluate prescription drug (Rx) claims and medical claims for the purpose of identifying potential subrogation opportunities arising from the incidence of injury from prescription drugs or toxic exposure.

### SUMMARY OF THE INVENTION

Accordingly, an object of the present invention is to provide a software system to support third party healthcare payors and other interested parties to assist them in identifying opportunities for pursuit of potential or actual recovery of funds reimbursed for prescription drug (Rx) claims and medical claims, to which there may exist a subrogation right (such as by plan members collecting settlement proceeds or legal recoveries for injuries or illness). The intent is to provide an application service provider (ASP) system that identifies Rx and medical subrogation opportunities from the healthcare payor's perspective by mining pharmaceutical and claims data for specific payable medical and pharmacy reactions that can be imputed back to suspect drugs and/or chemical exposure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an application service provider (ASP) system is disclosed that includes a software application which can mine pharmaceutical and claims data for specific payable medical and pharmacy reactions, and from a healthcare payor's perspective can identify Rx and medical subrogation opportunities. For example, the system can mine pharmaceutical and claims data for use of a drug which has a ‘black box’ warning or one that has been demonstrated to cause harm and identify the individuals who not only took that particular drug but had the adverse outcome. This even applies to a particular drug which causes a specific birth defect in babies born to women who have taken it while pregnant. The software is also able to identify specific diagnoses which can be imputed back to chemical exposure such as mesothelioma caused by exposure to asbestos. For example, Levaquin™ is used to treat severe or life threatening bacterial infections and is associated with a number of serious and life threatening adverse reactions as well as spontaneous tendon ruptures and irreversible peripheral neuropathy. Such reactions may manifest long after therapy had been completed and in severe cases may result in life long disabilities. Consequently, on Jul. 8, 2008, the FDA ordered a black box warning on Levaquin™. Though not currently a black box drug, acetaminophen is associated with liver toxicity (acetominophen is included in certain combination drugs such as Vicodan™ and Percocet™), and these potential (soon to be) torts can be identified. There are certain diagnoses which are a flag for those kinds of chemical exposures and the software is able to identify these as well. The software assists Health Plans in their ability to collect funds in cases where a plan member has collected payment for a pharmaceutical drug injury or illness, or chemical or toxin exposure outside of the Health Plan, even though the Health Plan has paid for the care of those individuals throughout their treatment/recovery/death from those exposures. The software might also assist law firms who frequently represent these individuals to find these members.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a screen print of the search menu for the dynamic information gathering module;

FIG. 2 is a screen print of the drop-down list of drugs;

FIG. 3 is a screen print of the results of a dynamic information gathering module search.

FIGS. 4-6 are screen prints of the Detailed view by which a user can ascertain Conditions, Historical pharmacy, and historical medical claims.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention is a system inclusive of a method and implementing software for providing third party healthcare payors with the information needed to recoup funds to which they have a subrogation right (including plan members that collected settlement proceeds or legal recoveries for injuries or illness). The software mines pharmaceutical and claims data (from a medical and Rx claims database) for specific payable medical and pharmacy reactions, and from a healthcare payor's perspective can identify opportunities where a plan member has been injured or has spent plan resources, even though they may be unaware that they have a potential claim, and flag those Rx and medical subrogation opportunities to the payor.

The software is preferably deployed on one or more web-enabled backend servers hosting a resident database and user interface in the form of a website that can be reached by remote computer login at an appropriately named URL such as, for example, https:\\secure.hcare.net. The back-end web-enabled server(s), database and website are maintained by a third party application service provider (‘ASP’).

The software includes a drug-specific dynamic information gathering module, which is a search-based data mining module for allowing a user to gather context-specific data from a claims database. The dynamic information gathering module presents a search menu comprising a plurality of search keys each including a drop-down list of selections.

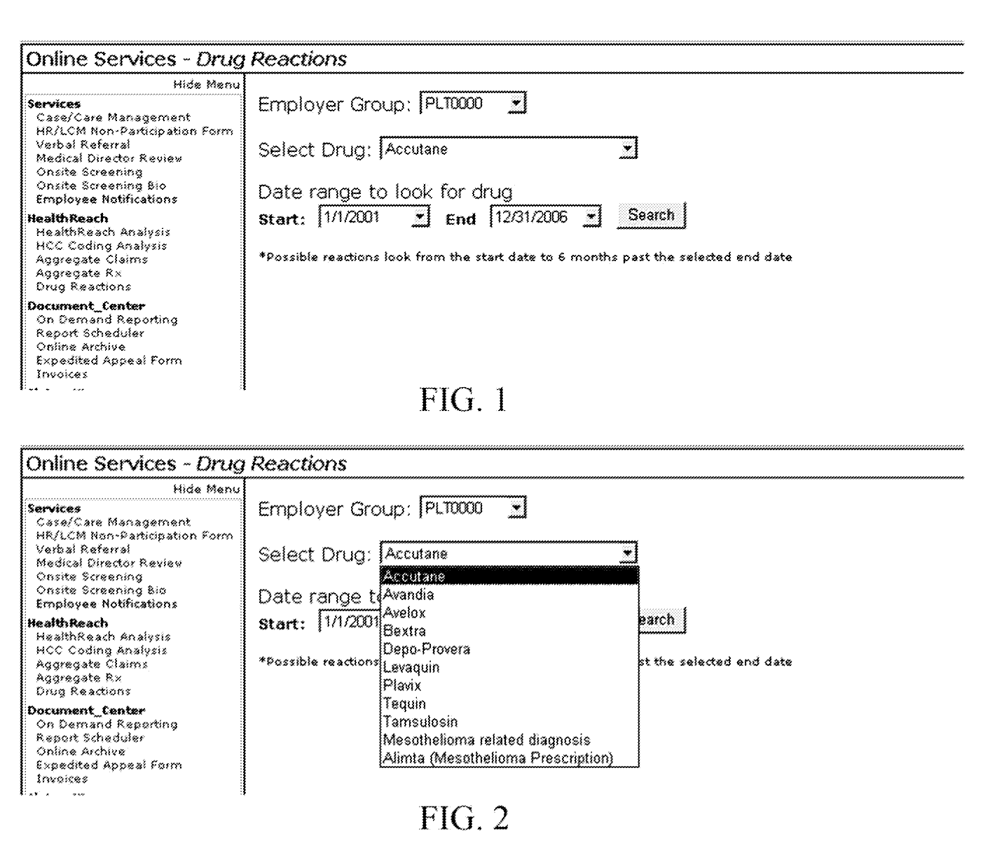

FIG. 1 is a screen print of the search menu for the dynamic information gathering module. The search keys include “Employer Group”, “Select Drug” and “Date range to look for drug” including “Start” and “End.” This search menu prompts the user to enter the necessary information to canvass an insurance claims database for records that involved taking a specific drug within a certain timeframe. A reminder is displayed to look from the start date to a user-defined end date, the end date being user-defined because reactions can be delayed. The search may be filtered by specific employer group clients (by their assigned numbers, such as PLT0000 as shown).

FIG. 2 is a screen print of the drop-down list of drugs, which as illustrated includes examples known to cause a reaction, such as Accutane, Avandia, Avelox, Bextra, Depo-Provera, Levaquin, Plavix Tequin, Tamsulosin, Mesothelioma related diagnosis; Alimta (Mesothelioma Prescription), and others. As new drugs are identified to be black box they are added into the database and appear in the drop down list.

Given a search, for example, within employer group client PLT0000 for patients taking Accutane between 1/1/2001 and 12/31/2006, the dynamic information gathering module will search the claims records for all records meeting the specified criteria.

The claims database may be any computerized health insurance claims database. Computerized health insurance claims databases are maintained largely for billing and administrative purposes, but these databases are also useful for describing health care utilization, patterns of care, disease prevalence, drug and disease outcomes, and cost of care. Insurance claims data includes outpatient drug information for patients younger than 65 years and, in some instances, for patients aged 65 years or older. For present purposes this is useful for querying drug outcomes and drug safety. Thus, the patient-claims records searched will include several types of data, such as, for example, healthcare administrative data, clinical data, health risk assessment (HRA), Rx and medical data, and/or other types of data. Healthcare administrative data may include data such as member demographics, health insurance eligibility information, data related to medical/pharmaceutical claims made in the past, provider demographic data, etc. In some instances, this data is provided directly by the patient or by the health Plan. The clinical data may include diagnostic laboratory results, biometric data, and/or other clinical data. Lab test results, which may be reported in the form of Logical Observation Identifiers Names and Codes (LOINC), as well as the dates of services may be included in the clinical data. Biometric data (e.g., blood pressure, height, weight, etc.) may be included as well. HRA information isself-reported by the patient. For example, a patient may complete a survey about their health history, personal habits, family history, allergies, conditions/medications, etc.

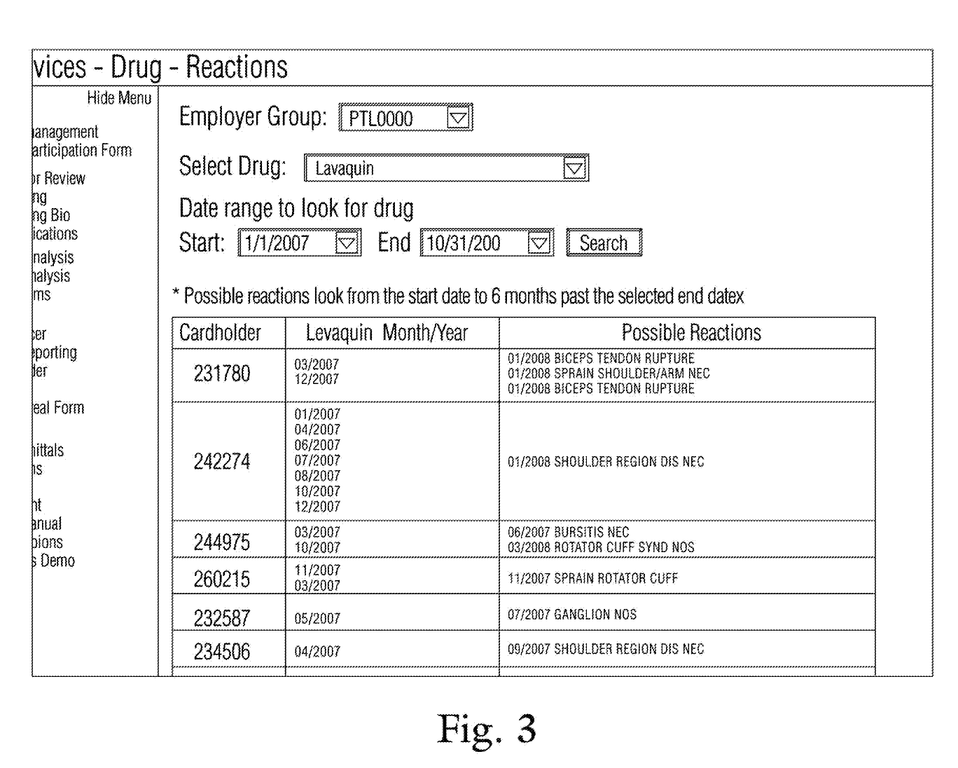

Given a search within an exemplary employer group (labeled client PLT0000) for patients taking Levaquin between 1/1/2007 and 10/31/2008, the dynamic information gathering module will search the claims records for all records meeting the specified criteria and display the results as shown in the screen print of FIG. 3.

The displayed results are presented categorically by patient identifier number (Cardholder), queried drug (Levaquin), Date Range (Month/Year), and the patient's Possible Reactions to that drug. For example, Cardholder no. 231780 took Levaquin in July of 2007 and again in December of 2007, and had three potentially correlated reactions including a BICEPS TENDON RUPTURE in 01/2008, a SPRAINed SHOULDER/ARM/NECK in 01/2008, and a BICEPS TENDON RUPTURE in 2/2008. The displayed results are likewise presented categorically for all patients exhibiting possible reactions to that drug within the specified date range. With the present system design any combination of drug(s) and possible medical side effect can be identified. The query logic looks at time frames of prescription and mines the health insurance claims database using a pre-defined “rule set”, e.g., a set of rules for identifying potential associations between the queried drug (Levaquin) taken within the specified Date Range (Month/Year), and the patient's Possible Reactions to that drug. There may be different associative rule sets for different drugs or combinations of drugs. Each rule set for each queriable drug (for example, Levaquin) contains a pre-programmed list of known adverse outcomes attributable to that drug by standard medical ICD or CPT code. There may be multiple rules for one drug, where each rule assigns a potential adverse outcome or combination of outcomes. The rule sets to be applied for a given drug may be specified in advance by an administrative user (the ASP), and the ruleset database may be maintained and updated as new medical studies indicate that specific drugs may have adverse consequences. Rule sets may have different levels of granularity, e.g., there may be direct cause-effect rules for specific drugs/diagnoses or more generalized rules mapping drugs to a range of possible ICD or CPT code values. Special rules (or separate rule sets) may be provided to handle such things as generic drug names versus brands, and other contextual anomalies. As an example, the ruleset maps specific drugs (or procedures or other causal factors) to specific ICD or CPT code values, diagnoses, or remedial procedures in order to identify, for instance:

conditions that would indicate exposure to specific materials such as asbestos;

side effects from taking a medication;

side effects on a child while the pregnant mother was taking the drug;

The user query searches the health insurance claims, for example, for prescriptions of the specified drug within the specified date range, and applies the ruleset to look for database ICD or CPT code values, diagnoses, or remedial procedures associated with possible adverse reactions.

The current rulesets/query types may be generally categorized as follows:

1. User Reaction

Search date range to look for a specific prescription taken by a member (as above);

Look for specific medical claims incurred that indicates a reaction to the drug during or within a given period of taking the prescription;

2. Mother to Baby Reaction

Search date range to look for a specific prescription taken by a mother while pregnant

Look for specific birth defects in a child diagnosed in the first two years of life, and suspect drugs taken by the mother;

3. Specific medical condition caused by outside source

Look for a specific medical condition (such as mesothelioma).

The results can be displayed on the website, through reports and delivered in mailings. The website incorporates a drill-down feature by which a user can click on any member and see detailed claims, pharmacy and condition information for that member.

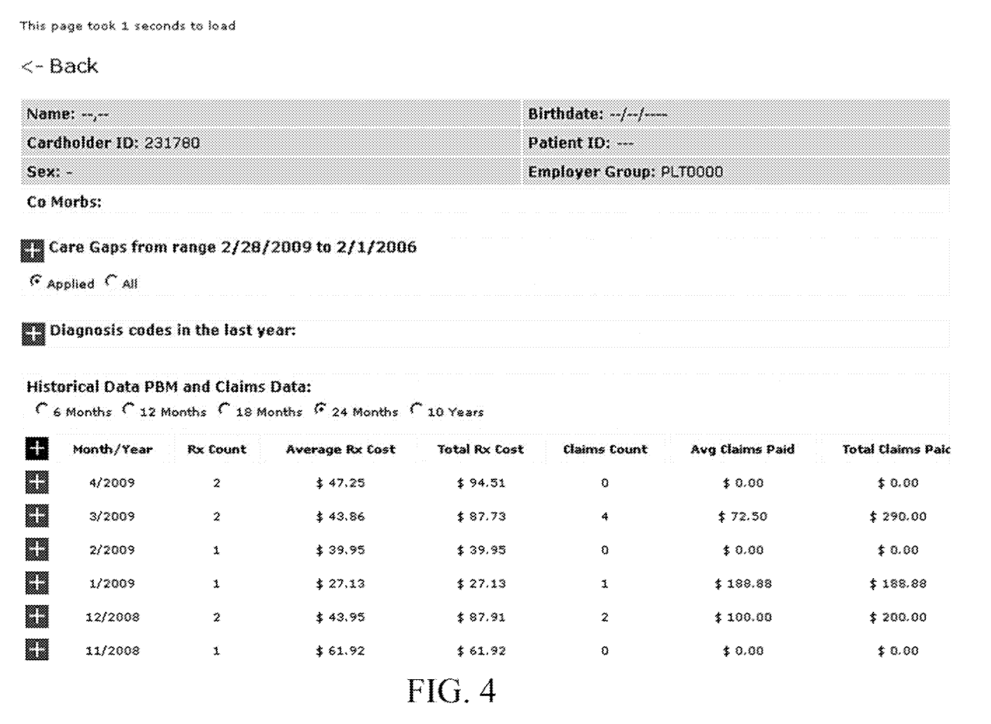

FIGS. 4-6 are screen prints of the Detailed view by which a user can ascertain Conditions, Historical pharmacy, and historical medical claims.

As seen in FIG. 4, the specific details include Care Gaps within the date range searched (here range 2/28/2009 to 2/1/2006), Diagnosis codes within the last year, and Historical Data PBM and Claims Data within a user-selectable range (6 Months, 12 Months, 18 Months, 24 Months or 10 Years). The Historical Data PBM and Claims Data includes prescription information for each prescription claim, stating Month/Year, Rx Count, Average Rx Cost, Total Rx Cost, Claims Count, Avg. Claims Paid, and Total Claims Paid. Thus, for insured member number 231780 an exemplary listing may appear as follows:

| Month/Year | Rx Count | Average Rx Cost | Total Rx Cost | Claims Count | Avg. Claims Paid | Total Claims Paid |
|---|---|---|---|---|---|---|
| April 2009 | 2 | $ 47.25 | $ 94.51 | 1 | $ 90 | $ 90 |

The user can readily ascertain whether the payor reimbursed the prescriptions, which may entitle it to a subrogation claim.

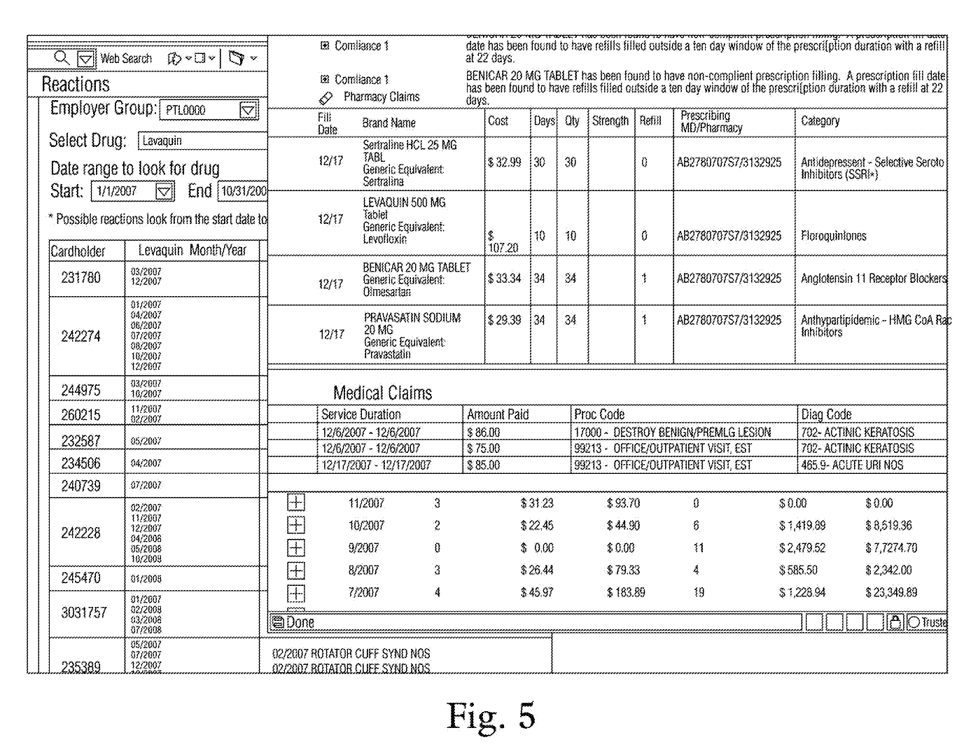

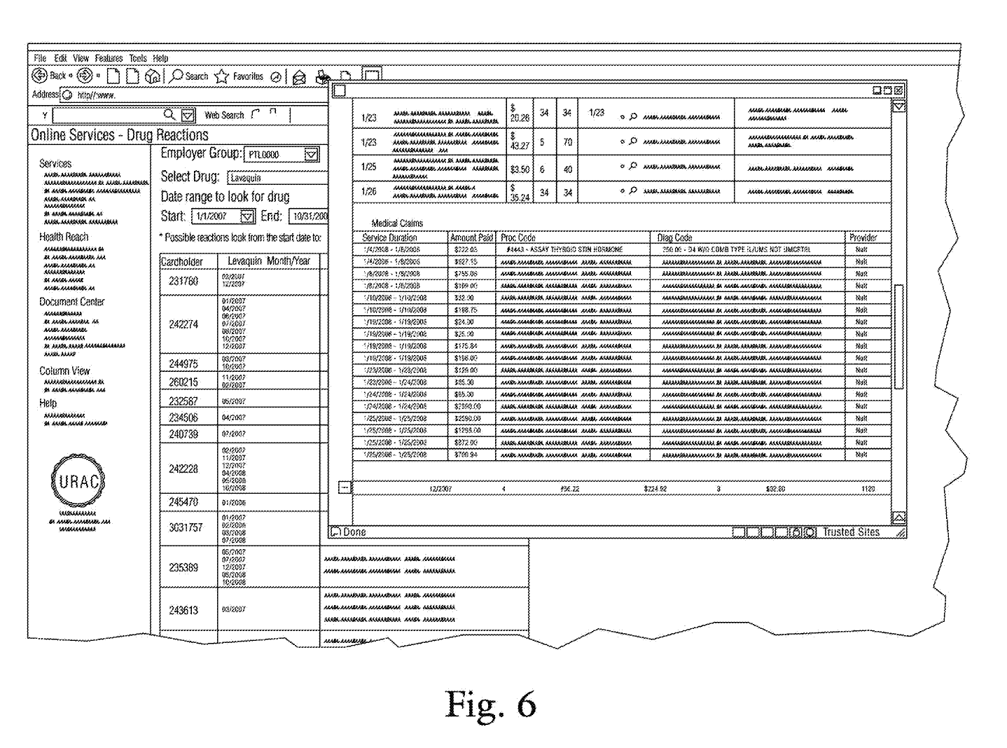

FIG. 5 adds further detail including Claims Data. The user attains FIG. 5 by clicking on the (+) plus icon next to the month/year shown in FIG. 4, which yields a line item detail of the detailed pharmacy and medical claims in that month.

It can readily be seen that this plan member filled a prescription for Levaquin 500 mg tablets on 12/17.

FIG. 6 adds further detail including Medical Data. FIG. 6 is the same level of detail as in FIG. 5, and is likewise the detailed view of the month which is found by clicking the on the (+) plus icon next to the month/year shown in FIG. 4.

Using the above-described software application a user can search for any identified drug that has a ‘black box’ warning, or one that has been demonstrated to cause harm, and identify all plan-members who took that particular drug and had an adverse outcome. This even applies to a particular drug which causes specific birth defects in babies born to women who have taken it while pregnant, a reverse correlation of the baby's adverse outcome to the much-earlier event that caused the outcome. The software is also able to identify specific diagnoses which can be imputed back to chemical exposure such as mesothelioma caused by exposure to asbestos, or liver toxicity caused by acetominophen (including combination drugs containing acetaminophen such as Vicodan™ and Percocet™ . . . certain diagnoses are a red flag for those kinds of chemical exposures and the software is able to identify these as well. This software application can be used for Health Plans that desire to collect funds they have paid for plan members in the event of any of the above scenarios. Moreover, should the member already have representation or have been compensated, the payor can pursue payment for all or part of the collected funds. If the plan member does not have representation, the payor can provide a referral list of law firms specializing in these torts.

Identifying such opportunities for both the payors and the plan members can potentially result in millions of dollars of savings and appropriate compensation for the injured patient.

If will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A software system for providing assistance to third party healthcare payors and others in recouping funds to which they have a subrogation right, comprising:
a health insurance claims database;
a web enabled computer server;
a dynamic information gathering module hosted on said web enabled computer server and accessible to a plurality of remote computer terminals, said dynamic information gathering module comprising a plurality of software instructions stored on a computer-readable medium for instructing a processor to search said health insurance claims database for all claims record all records meeting a specified criteria and display, and a search window for allowing a user to enter a selected black box drug and date range for searching said health insurance claims database.
